(19) United States
(12) Patent Application Publication
(10) Pub. No.: US 2017/0277420 A1
(43) Pub. Date: Sep. 28, 2017

(54) CONTROL METHOD AND DEVICE FOR TERMINAL

(71) Applicants: Le Holdings (Beijing) Co., Ltd., Beijing (CN); Lemobile Information Technology (Beijing) Co., Ltd, Beijing (CN)

(72) Inventor: Haosen Suo, Beijing (CN)

(21) Appl. No.: 15/334,227

(22) Filed: Oct. 25, 2016

Related U.S. Application Data
(63) Continuation of application No. PCT/CN2016/096428, filed on Aug. 23, 2016.

(30) Foreign Application Priority Data
Mar. 25, 2016 (CN) 2016101803482

(51) Int. Cl. G06F 3/0488; G06F 3/06

(52) U.S. Cl. CPC G06F 3/04883; G06F 3/0619; G06F 3/0652; G06F 3/067

(57) ABSTRACT

The embodiments of the present application provide a control method and device for a terminal. The control method for the terminal comprises: acquiring first operation information of a user at an edge touch area of the terminal; and cleaning up a memory of the terminal according to the first operation information of the user at the edge touch area of the terminal. In the technical solutions provided by the embodiments of the present application, when the memory of the terminal is cleaned, the operation is simple and convenient, the efficiency of cleaning up the memory of the terminal is improved, and the problem that the efficiency of cleaning up the memory of the terminal is relatively low existed in the prior art can be solved.

### CROSS REFERENCE TO RELATED APPLICATIONS

The present application is a continuation of international application No. PCT/CN2016/096428, filed on 23 Aug. 2016 which is based upon and claims the priority of Chinese Patent Application No. 201610180348.2, filed in Chinese Patent Office on Mar. 25, 2016, and entitled “CONTROL METHOD AND DEVICE FOR TERMINAL”, the entire contents of which are herein incorporated by reference.

### TECHNICAL FIELD

The present disclosure relates to the technical field of communications, and particularly relates to a control method and device for a terminal.

### BACKGROUND

Screens of conventional mainstream terminals are implemented as touch screens, and users operate the terminals by clicking or swiping functional keys on the touch screens and the like.

In order to ensure the running speed of a terminal, the terminal generally has a memory cleaning-up function. For example, application programs in the terminal, after being used, may run in the background, or some historical data such as files and registries are generated so that the memory occupancy rate of the terminal is relatively high and the running speed of the terminal is influenced, and a user can clean up the memory of the terminal via a cleaning up tool installed in the terminal to ensure the running speed of the terminal.

In the process of implementing the present invention, the inventor discovers that the prior art at least has the following problems: when the memory of the terminal is cleaned via the cleaning-up tool, the cleaning-up tool needs to be started, and then the cleaning up button is clicked, so the operation process is complex. As the touch screen of the terminal is increasingly large, inconvenient operation is also caused; thus, the efficiency of cleaning up the memory of the terminal is relatively low in the prior art.

### SUMMARY

In view of this, the embodiments of the present disclosure provide a control method and device for a terminal for solving the problem that the efficiency of cleaning up a memory of the terminal is relatively low in the prior art.

To fulfill the above inventive object, in one aspect, an embodiment of the present disclosure provides a control method for a terminal, adapted to be used by a server. The method includes: acquiring first operation information of a user at an edge touch area of the terminal; and cleaning up a memory of the terminal according to the first operation information of the user at the edge touch area of the terminal.

To fulfill the above inventive object, in a further aspect, an embodiment of the present disclosure further provides a terminal, including at least one processor and a memory in communication connection with the at least one processor, wherein the memory stores an instruction executable by the at least one processor, and the instruction is executed by the at least one processor, so that the at least one processor can acquire first operation information of a user at an edge touch area of the terminal; and clean a memory of the terminal according to the first operation information of the user at the edge touch area of the terminal.

To fulfill the above inventive object, in a further aspect, an embodiment of the present disclosure further provides a non-volatile computer readable storage medium, which stores a computer executable instruction, the computer executable instruction is used for: acquiring first operation information of a user at an edge touch area of the terminal; and cleaning up a memory of the terminal according to the first operation information of the user at the edge touch area of the terminal.

### BRIEF DESCRIPTION OF DRAWINGS

One or more embodiments are illustrated by way of example via figures in corresponding drawings, these illustrations do not limit the embodiments, components with the same reference numerical signs in the drawings represent similar elements, and the figures in the drawings do not have proportional limitations unless otherwise specified.

FIG. 1 is a flow diagram of embodiment 1 of a control method for a terminal provided by an embodiment of the present disclosure;

FIG. 2 is an exemplary diagram of an edge touch area of the terminal provided by an embodiment of the present disclosure;

FIG. 3 is a flow diagram of embodiment 2 of a control method for a terminal provided by an embodiment of the present disclosure;

FIG. 4 is a structural schematic diagram of a control device for a terminal provided by an embodiment of the present disclosure;

FIG. 5 is a schematic diagram of a hardware structure of a terminal for executing the control method for the terminal provided by an embodiment of the present disclosure.

### DETAILED DESCRIPTION

Preferred embodiments of the present disclosure will be illustrated below in combination with the accompanying drawings. It should be understood that the preferred embodiments described herein are merely used for illustrating and interpreting the present disclosure, rather than limiting the present disclosure.

It should be clear that the described embodiments are merely part of, not all of the embodiments of the present disclosure. Based on the embodiments in the present disclosure, all other embodiments obtained by those of ordinary skill in the art without any creative effort shall be within the protection scope of the present disclosure.

The terms used in the embodiments of the present disclosure are for describing specific embodiments only, rather than limiting the present disclosure. Singular forms “one”, “said” and “the” used in the embodiments and the appended claims of the present disclosure also intend to include plural forms, unless the context clearly expresses other meanings.

It should be understood that the term “and/or” used in the present disclosure is merely an association relation for describing associated objects, and can express three relations, for example, A and/or B can express: single A, both A and B, and single B. In addition, the symbol “/” in the present disclosure generally expresses an “or” relation between consecutive associated objects.

It should be understood that the terms including first, second and the like may be adopted in the embodiments of the present disclosure to describe the operation information, but the operation information is not limited to these terms. These terms are merely used for distinguishing the operation information. For example, the first operation information may also be referred to as the second operation information without departing from the scope of the embodiments of the present disclosure, and similarly, the second operation information may also be referred to as the first operation information.

Upon the context, the word “if” used herein can be interpreted as “at the time of . . . ” or “when . . . ” or “responding to determining” or “responding to detecting”. Similarly, upon the context, the phrase “if determining” or “if detecting (the stated condition or event)” can be interpreted as “when determining” or “responding to determine” or “when detecting (the stated condition or event)” or “responding to detect (the stated condition or event)”.

### Embodiment 1

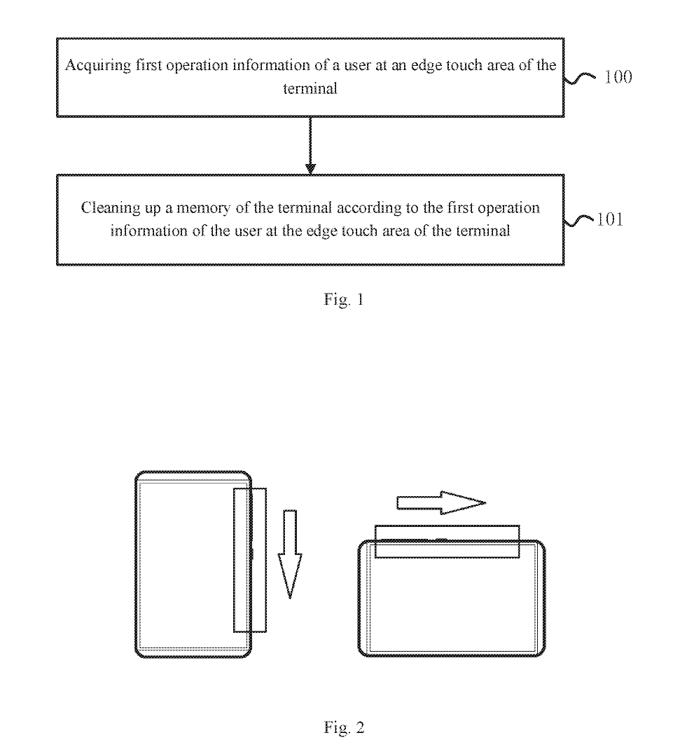

FIG. 1 is a flow diagram of embodiment 1 of a control method for a terminal in an embodiment of the present disclosure. As shown in FIG. 1, the control method of this embodiment may include steps 100˜101 below.

100, acquiring first operation information of a user at an edge touch area of the terminal.

For example, the terminal involved in the embodiment of the present disclosure may include but not limited to a personal computer (PC), a personal digital assistant (PDA), a wireless handheld device, a tablet computer, a mobile phone, an MP3 player, an MP4 player, etc.

In the embodiment of the present disclosure, the first operation information of the user at the edge touch area of the terminal may include but not limited to: first operation information generated after swiping operation of the user at the edge touch area of the terminal, e.g., swiping gesture; or first operation information generated after clicking operation of the user at the edge touch area of the terminal, e.g., click number; or first operation information generated after pressing operation of the user at the edge touch area of the terminal, e.g., pressure value.

It could be understood that edge touch provides touch input via the edge or the border of the terminal to track clicking, swiping or pressing of a finger on the edge of the terminal so as to control the mobile phone.

Please refer to FIG. 2, which is an exemplary diagram of an edge touch area of the terminal provided by an embodiment of the present disclosure. As shown in FIG. 2, the edge touch area of the terminal may be an area that the finger of the user can reach on the sides of the terminal when the user naturally holds the terminal, and the sides of the terminal include other four sides except the front side and the back side.

In the embodiment of the present disclosure, the edge touch area of the terminal may be realized by a physical key, a virtual key, a sensor or a screen.

For example, if the terminal uses a curved screen, the edge touch area of the terminal can be implemented as the edge screen of the curved screen. Taking a capacitive touch screen as an example for illustration, when the finger of the user touches the edge touch screen, the capacitance of the contact is changed, so that the frequency of an oscillator connected with a capacitor is changed, the touch position can be determined by measuring the change of the frequency of the oscillator, and then the first operation information of the user at the edge touch area of the terminal can be acquired.

Or, for another example, the edge touch area of the terminal not using a curved screen can be realized by a physical key, a virtual key or a sensor.

For example, if a physical key for adjusting the volume is at the edge of the terminal, the physical key for adjusting the volume in the terminal is taken as an example for illustrating, when the finger of the user presses the physical key for adjusting the volume, the terminal may learn that the user presses the key for improving the volume or the key for lowering the volume, and similarly, if the touch of the user at the edge tends to pressing operation, the first operation information of the user at the edge touch area of the terminal can be acquired.

For another example, if virtual keys with certain functions are at the edge of the terminal and when the virtual keys are capacitive virtual keys, the terminal judges which virtual key the user touches via the capacitance of the capacitive virtual keys. Specifically, the finger and the electrode plate in a capacitive virtual key may form a capacitor when the user touches the capacitive virtual key, the terminal determines the touch position of the user by detecting the change of the capacitance so as to determine which virtual key the user touches, and then the first operation information of the user at the edge touch area of the terminal can be acquired.

For a further example, if sensors with certain functions are at the edge of the terminal, the sensors which are pressure sensors on the terminal are taken as an example, when the user presses a pressure sensor, semiconductor deformation pressure is formed on the flaky surface of the pressure sensor, the flaky surface is deformed by pressing to produce a piezoelectric impedance effect, the change of the impedance is converted into an electrical signal, and after acquiring the electrical signal, the terminal can determine which pressure sensor the user presses or which position on the pressure sensor the user presses so as to determine which function of the pressure sensor the user presses, and then the first operation information of the user at the edge touch area of the terminal can be acquired. In addition, the sensors with certain functions at the edge of the terminal may also be photo sensors.

Specifically, acquiring first operation information of a user at an edge touch area of the terminal means acquiring first operation information of the user at a valid area of the edge touch area of the terminal, and only the operation in the valid area can generate corresponding first operation information.

For example, if the terminal uses a curved screen, when the first operation information of the user is acquired using the edge screen of the curved screen at the edge touch area of the terminal, the valid area of the edge screen is a screen edge area that the finger of the user can click or contact when the user naturally holds the terminal.

101, cleaning up a memory of the terminal according to the first operation information of the user at the edge touch area of the terminal.

Specifically, different first operation information is generated when the user carries out different operations on the terminal, and then corresponding functional modules of the terminal are triggered to fulfill the purpose the first operation information needs to achieve. Thus, the purpose fulfilled by the first operation information of the user at the edge touch area of the terminal can be preset in the terminal.

For example, some application programs running in the background and historical data such as files and registries may be present when the terminal is used, occupy the memory of the terminal and influence the running speed of the terminal.

When the user naturally holds the terminal, the finger easily touches the edge touch area of the terminal, so in order to conveniently and quickly clean the memory of the terminal, the purpose to be fulfilled by the first operation information of the user at the edge touch area of the terminal can be set to clean the memory of the terminal. In this case, when the phenomena of slow running speed and the like appear at the terminal, it indicates that the memory occupation rate of the terminal is large, the user can carry out operation at the edge touch area of the terminal at the moment, and after the first operation information of the user at the edge touch area of the terminal is acquired, the first operation information may trigger memory cleaning up of the terminal.

It should be noted that the execution main body of the control method for the terminal in the embodiment of the present disclosure may be a control device for the terminal, the device may be located at an disclosure of the local terminal or at a functional unit such as a plug-in or software development kit (SDK) and the like in the disclosure of the local terminal, and the embodiment of the present disclosure is not specially limited thereto.

It could be understood that the disclosure may be an disclosure program (nativeApp) installed on the terminal or a web program (webApp) of a browser on the terminal, and the embodiment of the present disclosure is not limited thereto.

In the control method for the terminal provided by the embodiment of the present disclosure, first operation information of a user at an edge touch area of the terminal is acquired; and a memory of the terminal is cleaned according to the first operation information of the user at the edge touch area of the terminal. In the present disclosure, the memory of the terminal can be conveniently and quickly cleaned by operation at the edge touch area of the terminal. Thus, in the technical solution of the present disclosure, when the memory of the terminal is cleaned, the operation is simple and convenient, the efficiency of cleaning up the memory of the terminal is improved, and the problem that the efficiency of cleaning up the memory of the terminal is relatively low in the prior art can be solved.

### Embodiment 2

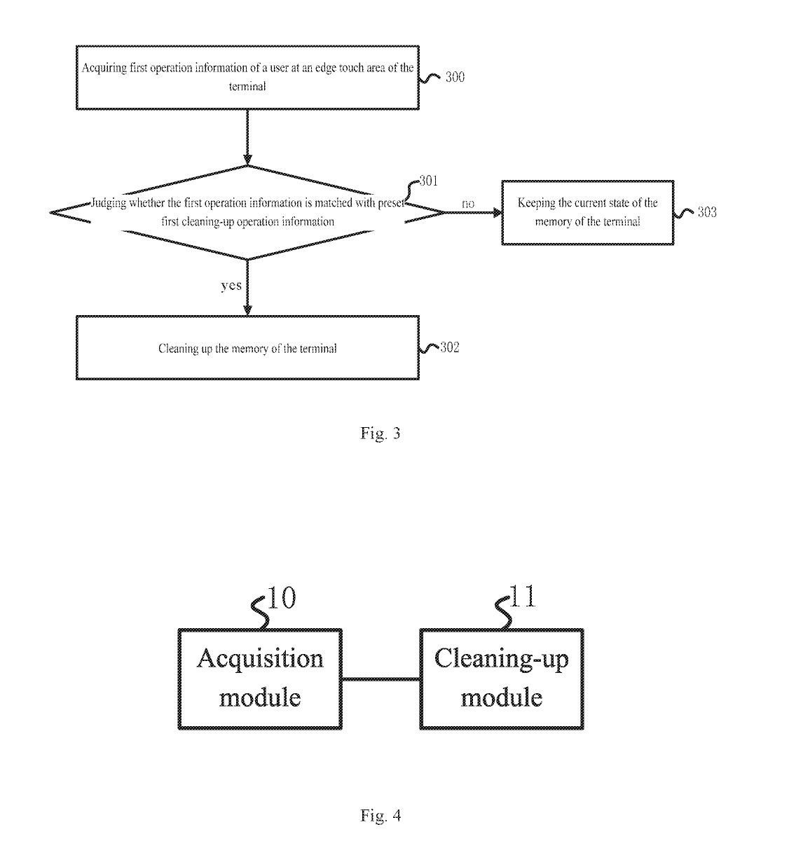

FIG. 3 is a flow diagram of embodiment 2 of a control method for a terminal provided by an embodiment of the present disclosure. As shown in FIG. 3, the control method for the terminal provided by the embodiment of the present disclosure further describes the technical solution of the embodiment of the present disclosure based on the embodiment shown in FIG. 1.

As shown in FIG. 3, the control method for the terminal provided by the embodiment of the present disclosure may specifically include steps 300˜303 below.

300, acquiring first operation information of a user at an edge touch area of the terminal.

301, judging whether the first operation information is matched with preset first cleaning-up operation information or not; if judging that the first operation information is matched with the first cleaning-up operation information, executing step 302; otherwise, if judging that the first operation information is not matched with the first cleaning-up operation information, executing step 303.

First cleaning-up operation information is preset in the terminal; after the first operation information of the user at the edge touch area of the terminal is acquired, the first operation information is matched with the preset first cleaning-up operation information, and then whether the first operation information is the preset first cleaning-up operation information or not is judged; if the acquired first operation information is the preset first cleaning-up operation information, it indicates that the first operation information of the user at the edge touch area of the terminal is used for triggering memory cleaning up of the terminal, and step 302 is thus executed; otherwise, if the acquired first operation information is not the preset first cleaning-up operation information, it indicates that the first operation information of the user at the edge touch area of the terminal is not used for triggering memory cleaning up of the terminal, and step 303 is thus executed.

302, cleaning up the memory of the terminal.

For example, the first cleaning-up operation information is a preset click number, then if the acquired operation of the user at the edge touch area of the terminal is clicking operation at the edge touch area of the terminal, the click number of the clicking operation at the edge touch area of the terminal is compared with the preset click number, and if the click number of the clicking operation at the edge touch area of the terminal is greater than or equal to the preset click number, the memory of the terminal is cleaned.

However, it generally takes long time to clean historical data of the terminal, this process may result in the situation that the user cannot use the terminal, and if only the application programs running in the background of the terminal are cleaned, the user can use the terminal normally and clean the memory of the terminal, so the user can select the cleaning up mode according to actual needs.

Specifically, the same principle as the above cleaning up mode can be adopted, that is, second operation information of the user at the edge touch area of the terminal can be further acquired. Whether the second operation information is matched with preset second cleaning-up operation information or not is judged; and if the second operation information is matched with the second cleaning-up operation information, the memory of the terminal is deeply cleaned. If the second operation information is not matched with the second cleaning-up operation information, the memory of the terminal is quickly released.

In the embodiment of the present disclosure, the second operation information of the user at the edge touch area of the terminal may include but not limited to second operation information generated after swiping operation of the user at the edge touch area of the terminal, e.g., swiping gesture; or second operation information generated after clicking operation of the user at the edge touch area of the terminal, e.g., click number; or second operation information generated after pressing operation of the user at the edge touch area of the terminal, e.g., pressure value.

In this embodiment, the first operation information and the second operation information may be the same or different. Since the acquired first operation information and second operation information correspond to different functions respectively, the first operation information and the second operation information being different in this embodiment is taken as an example. For example, the second operation information in this embodiment is a pressure value generated after pressing operation of the user at the edge touch area of the terminal, and the corresponding second cleaning-up operation information is a preset pressure threshold. After the pressure value generated after pressing operation of the user at the edge touch area of the terminal is acquired, the pressure value is compared with the preset pressure threshold; and if the pressure value generated after pressing operation of the user at the edge touch area of the terminal is greater than or equal to the preset pressure threshold, only the application programs running in the background of the terminal are cleaned, that is, the memory of the terminal is quickly released. Otherwise, if the pressure value generated after pressing operation of the user at the edge touch area of the terminal is smaller than the preset pressure threshold, both the application programs running in the background of the terminal and historical data generated when the terminal is used are cleaned, that is, the memory of the terminal is deeply cleaned.

It should be noted that this embodiment is merely illustrated using the fact that the acquired first operation information is a click number and the acquired second operation information is a pressure value as an example, but this embodiment is not limited to this implementation. For example, a swiping gesture and the like may also be adopted, their implementation principle is the same as that of this embodiment, and reference may be made to the above relevant description for details, which is not redundantly described herein.

303, keeping the current state of the memory of the terminal.

If the click number of the clicking operation at the edge touch area of the terminal is smaller than the preset click number, the current state of the memory of the terminal is kept, that is, the memory of the terminal is not cleaned.

According to the control method for the terminal provided by the embodiment of the present disclosure, in the process of cleaning up the memory of the terminal, second operation information of the user at the edge touch area of the terminal is acquired; and the memory of the terminal is cleaned on different degrees according to the second operation information of the user at the edge touch area of the terminal. In the present disclosure, the memory of the terminal can be conveniently and quickly cleaned on different degrees by operation at the edge touch area of the terminal. Thus, the technical solution of the present disclosure has the advantages that when the memory of the terminal is cleaned, the operation is simple and convenient, the efficiency of cleaning up the memory of the terminal is improved, and the problem that the efficiency of cleaning up the memory of the terminal is relatively low in the prior art can be solved.

### Embodiment 3

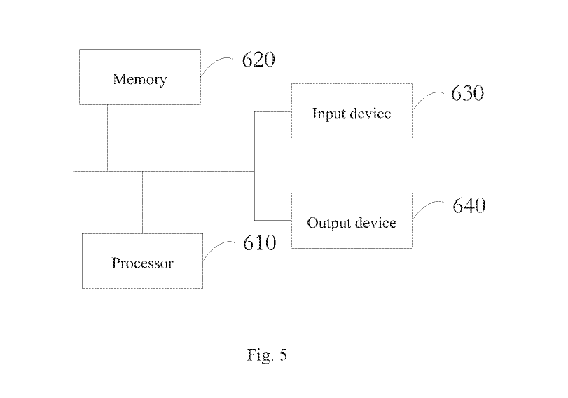

FIG. 4 is a structural schematic diagram of a control device for a terminal provided by an embodiment of the present disclosure. As shown in FIG. 4, the control device for the terminal provided by the embodiment of the present disclosure includes an acquisition module 10 and a cleaning-up module 11.

In a specific implementation process, information data and the like can be transmitted between the modules.

The acquisition module 10 is used for acquiring first operation information of a user at an edge touch area of the terminal.

The cleaning-up module 11 is used for cleaning up a memory of the terminal according to the first operation information of the user at the edge touch area of the terminal.

In the control device for the terminal provided by the embodiment of the present disclosure, the implementation mechanism of cleaning up the memory of the terminal by adopting the above modules is the same as that of the embodiment shown in FIG. 1 above, and reference may be made to the description of the embodiment shown in FIG. 1 for details, which is not redundantly described herein.

In the control device for the terminal provided by the embodiment of the present disclosure, an acquisition module 10 in the terminal acquires first operation information of a user at an edge touch area of the terminal; and a cleaning-up module 11 in the terminal cleans a memory of the terminal according to the first operation information of the user at the edge touch area of the terminal. In the present disclosure, the memory of the terminal can be conveniently and quickly cleaned by operation at the edge touch area of the terminal. Thus, in the technical solution of the present disclosure, when the memory of the terminal is cleaned, the operation is simple and convenient, the efficiency of cleaning up the memory of the terminal is improved, and the problem that the efficiency of cleaning up the memory of the terminal is relatively low in the prior art can be solved.

Further, in a specific implementation process, the cleaning-up module 11 in the control device for the terminal of the above embodiment is specifically used for: judging whether the first operation information is matched with preset first cleaning-up operation information or not; and if judging that the first operation information is matched with the first cleaning-up operation information, cleaning up the memory of the terminal.

Specifically, the cleaning-up module 11 can be further used for acquiring second operation information of the user at the edge touch area of the terminal; judging whether the second operation information is matched with preset second cleaning-up operation information or not; if judging that the second operation information is matched with the second cleaning-up operation information, deeply cleaning up the memory of the terminal; and if judging that the second operation information is not matched with the second cleaning-up operation information, quickly releasing the memory of the terminal.

The first operation information of the user at the edge touch area of the terminal or the second operation information of the user at the edge touch area of the terminal includes: operation information generated after swiping operation of the user at the edge touch area of the terminal; or operation information generated after clicking operation of the user at the edge touch area of the terminal; or operation information generated after pressing operation of the user at the edge touch area of the terminal.

Further, in a specific implementation process, the cleaning-up module 11, in the control device for the terminal of the above embodiment, is further used for: if judging that the first operation information is not matched with the first cleaning-up operation information, keeping the current state of the memory of the terminal.

In the control device for the terminal provided by the embodiment of the present disclosure, the implementation mechanism of cleaning up the memory of the terminal by adopting the above modules is the same as that of the embodiment shown in FIG. 3 above, and reference may be made to the description of the embodiment shown in FIG. 3 for details, which is not redundantly described herein.

### Embodiment 4

The embodiment of the present disclosure provides a non-volatile computer storage medium, the computer storage medium stores a computer executable instruction, and the computer executable instruction can execute the processing method in any above method embodiment.

### Embodiment 5

FIG. 5 is a schematic diagram of a hardware structure of a terminal for executing the control method for the terminal provided by an embodiment of the present disclosure. As shown in FIG. 5, the terminal includes one or more processors 610 and a memory 620. One processor 610 is taken as an example in FIG. 5. The terminal may further include an input device 630 and an output device 640.

The processor 610, the memory 620, the input device 630 and the output device 640 can be connected via a bus or in other mode, taking bus connection as an example in FIG. 5.

The memory 620 serving as a non-volatile computer readable storage medium can be used for storing non-volatile software programs, non-volatile computer executable programs and modules. The processor 610 runs the non-volatile software programs, instructions and programs stored in the memory 620 to execute various functional disclosures and data processing of the terminal, i.e., to implement the processing methods in the above method embodiments.

The memory 620 may include a program storage area and a data storage area, wherein the program storage area can store an operating system and an disclosure program required by at least one function; and the data storage area can store data and the like. Moreover, the memory 620 may include a high-speed random access memory, and may also include a non-volatile memory, e.g., at least one disk storage device, a flash device or other non-volatile solid-state storage device. In some embodiments, the memory 620 may include memories arranged remotely relative to the processor 610, and these remote memories can be connected to the processor via a network. The example of the network includes but not limited to the internet, an intranet, a local area network, a mobile communication network and a combination thereof.

The input device 630 can receive input digital or character information and generate signal input. The output device 640 may include display equipment such as a display screen.

The one or more modules are stored in the memory 620, and are executed by the one or more processors 610 to execute: acquiring first operation information of a user at an edge touch area of the terminal; and cleaning up a memory of the terminal according to the first operation information of the user at the edge touch area of the terminal.

In a possible implementation, the cleaning up a memory of the terminal according to the first operation information of the user at the edge touch area of the terminal includes: judging whether the first operation information is matched with preset first cleaning-up operation information or not; and if judging that the first operation information is matched with the first cleaning-up operation information, cleaning up the memory of the terminal.

In a possible implementation, the if judging that the first operation information is matched with the preset first cleaning-up operation information, cleaning up the memory of the terminal includes: acquiring second operation information of the user at the edge touch area of the terminal; judging whether the second operation information is matched with preset second cleaning-up operation information or not; and if judging that the second operation information is matched with the second cleaning-up operation information, deeply cleaning up the memory of the terminal.

In a possible implementation, the method further includes: if judging that the second operation information is not matched with the second cleaning-up operation information, quickly releasing the memory of the terminal.

In a possible implementation, the method further includes: if judging that the first operation information is not matched with the first cleaning-up operation information, keeping the current state of the memory of the terminal.

In a possible implementation, the first operation information of the user at the edge touch area of the terminal or the second operation information of the user at the edge touch area of the terminal includes: operation information generated after swiping operation of the user at the edge touch area of the terminal; or operation information generated after clicking operation of the user at the edge touch area of the terminal; or operation information generated after pressing operation of the user at the edge touch area of the terminal.

The above product can execute the methods provided by the embodiments of the present disclosure, and has corresponding functional modules for executing the methods and corresponding beneficial effects. For the technical details not described in detail in this embodiment, reference may be made to the methods provided by the embodiments of the present disclosure.

The terminal in the embodiments of the present disclosure exists in multiple forms, including but not limited to:

Mobile communication equipment: this type of equipment has a mobile communication function, and has main goals of providing voice and data communication. The terminal includes a smart phone (e.g., iPhone), a multimedia phone, a functional phone, a low-end phone, etc.

Ultra-mobile personal computer equipment: this type of equipment belongs to the scope of personal computers, has computing and processing functions, and generally also has a mobile internet characteristic. The terminal includes PAD, an MID (Mobile Internet Device) and UMPC (Ultra Mobile Personal Computer) equipment and the like, e.g., iPad.

Portable entertainment equipment: this type of equipment can display and play multimedia contents. The equipment includes audio and video players (e.g., iPod), a handheld game player, an electronic book, an intelligent toy and portable vehicle-mounted navigation equipment.

Server: the server is used for providing computing services, including a processor, a hard disk, a memory, a system bus, etc., wherein the architecture of the server is similar to that of a general computer, but the server is highly required on the aspects of processing capability, stability, reliability, security, expandability, manageability and the like because it needs to provide highly reliable services.

Other electronic devices with a data interaction function.

The above-described device embodiments are only schematic, wherein the units illustrated as separate components may be or may not be physically separated, and the components displayed as units may be or may not be physical units, that is to say, the components may be positioned at one place or may also be distributed on a plurality of network units. The objectives of the solutions of the embodiments may be fulfilled by selecting part of or all of the modules according to actual needs.

Upon the descriptions of the above embodiments, those skilled in the art can clearly learn that each embodiment can be realized by means of software and a general hardware platform, and of course, can be realized via hardware. Based on such an understanding, the above technical solutions substantially or the parts making contribution to relevant technologies may be embodied in the form of a software product, and the computer software product can be stored in a storage medium, such as an ROM (Read-Only Memory)/RAM (Random Access Memory), a magnetic disk, an optical disk, etc., which includes a plurality of instructions enabling computer equipment (which may be a personal computer, a server, or network equipment or the like) to execute each embodiment or the method in some part of each embodiment.

Finally, it should be noted that the above embodiments are merely used for illustrating the technical solutions of the present disclosure, rather than limiting the present disclosure; though the present disclosure is illustrated in detail with reference to the aforementioned embodiments, it should be understood by those of ordinary skill in the art that modifications may still be made on the technical solutions disclosed in the aforementioned respective embodiments, or equivalent substitutions may be made to a part of technical features thereof; and these modifications or substitutions do not make the essence of the corresponding technical solutions depart from the spirit and scope of the technical solutions of the respective embodiments of the present disclosure.

### INDUSTRIAL APPLICABILITY

According to the control method and device for the terminal provided by the embodiments of the present disclosure, first operation information of a user at an edge touch area of the terminal is acquired, and a memory of the terminal is cleaned according to the first operation information of the user at the edge touch area of the terminal, so that when the memory of the terminal is cleaned, the operation is simple and convenient, and the efficiency of cleaning up the memory of the terminal is improved.

1. A control method for a terminal, adapted to be used by a server, said method comprising:
acquiring first operation information of a user at an edge touch area of the terminal; and
cleaning up a memory of the terminal according to the first operation information of the user at the edge touch area of the terminal.

2. The method of claim 1, wherein the step of cleaning up a memory of the terminal according to the first operation information of the user at the edge touch area of the terminal comprises:
judging whether the first operation information is matched with a preset first cleaning-up operation information; and
if judging that the first operation information is matched with the first cleaning-up operation information, cleaning up the memory of the terminal.

3. The method of claim 2, wherein if judging that the first operation information is matched with the preset first cleaning-up operation information, the step of cleaning up the memory of the terminal comprises:
acquiring second operation information of the user at the edge touch area of the terminal;
judging whether the second operation information is matched with preset second cleaning-up operation information; and
if judging that the second operation information is matched with the second cleaning-up operation information, deeply cleaning up the memory of the terminal.

4. The method of claim 3, wherein the method further comprises:
if judging that the second operation information is not matched with the second cleaning-up operation information, quickly releasing the memory of the terminal.

5. The method of claim 2, wherein the method further comprises:
if judging that the first operation information is not matched with the first cleaning-up operation information, keeping the current state of the memory of the terminal.

6. The method of claim 3, wherein the first operation information of the user at the edge touch area of the terminal or the second operation information of the user at the edge touch area of the terminal comprises:
operation information generated after swiping operation of the user at the edge touch area of the terminal; or
operation information generated after clicking operation of the user at the edge touch area of the terminal; or
operation information generated after pressing operation of the user at the edge touch area of the terminal.

7. A terminal, comprising:
at least one processor; and
a memory in communication connection with the at least one processor, wherein
the memory stores an instruction executable by the at least one processor, and the instruction is executed by the at least one processor, so that the at least one processor can acquire first operation information of a user at an edge touch area of the terminal; and
clean a memory of the terminal according to the first operation information of the user at the edge touch area of the terminal.

8. The terminal of claim 7, wherein the cleaning up a memory of the terminal according to the first operation information of the user at the edge touch area of the terminal comprises:
judging whether the first operation information is matched with preset first cleaning-up operation information or not; and
if judging that the first operation information is matched with the first cleaning-up operation information, cleaning up the memory of the terminal.

9. The terminal of claim 8, wherein if the judging that the first operation information is matched with the preset first cleaning-up operation information, cleaning up the memory of the terminal comprises:
acquiring second operation information of the user at the edge touch area of the terminal;
judging whether the second operation information is matched with preset second cleaning-up operation information or not; and
if judging that the second operation information is matched with the second cleaning-up operation information, deeply cleaning up the memory of the terminal.

10. The terminal of claim 9, wherein the instruction is executed by the at least one processor, so that the at least one processor can:
if judging that the second operation information is not matched with the second cleaning-up operation information, quickly release the memory of the terminal.

11. The terminal of claim 8, wherein the instruction is executed by the at least one processor, so that the at least one processor can:
if judging that the first operation information is not matched with the first cleaning-up operation information, keep the current state of the memory of the terminal.

12. The terminal of claim 9, wherein the first operation information of the user at the edge touch area of the terminal or the second operation information of the user at the edge touch area of the terminal comprises:
operation information generated after swiping operation of the user at the edge touch area of the terminal; or
operation information generated after clicking operation of the user at the edge touch area of the terminal; or
operation information generated after pressing operation of the user at the edge touch area of the terminal.

13. A non-volatile computer readable storage medium, wherein the non-volatile computer readable storage medium stores a computer executable instruction, which is used for acquiring first operation information of a user at an edge touch area of the terminal; and
cleaning up a memory of the terminal according to the first operation information of the user at the edge touch area of the terminal.

14. The non-volatile computer readable storage medium of claim 13, wherein the cleaning up a memory of the terminal according to the first operation information of the user at the edge touch area of the terminal comprises:
judging whether the first operation information is matched with preset first cleaning-up operation information or not; and
if judging that the first operation information is matched with the first cleaning-up operation information, cleaning up the memory of the terminal.

15. The non-volatile computer readable storage medium of claim 14, wherein the if judging that the first operation information is matched with the preset first cleaning-up operation information, cleaning up the memory of the terminal comprises:
acquiring second operation information of the user at the edge touch area of the terminal;
judging whether the second operation information is matched with preset second cleaning-up operation information or not; and
if judging that the second operation information is matched with the second cleaning-up operation information, deeply cleaning up the memory of the terminal.

16. The non-volatile computer readable storage medium of claim 15, wherein the computer executable instruction is used for:
if judging that the second operation information is not matched with the second cleaning-up operation information, quickly releasing the memory of the terminal.

17. The non-volatile computer readable storage medium of claim 14, wherein the computer executable instruction is used for:
if judging that the first operation information is not matched with the first cleaning-up operation information, keeping the current state of the memory of the terminal.

18. The non-volatile computer readable storage medium of any of claim 15, wherein the first operation information of the user at the edge touch area of the terminal or the second operation information of the user at the edge touch area of the terminal comprises:
operation information generated after swiping operation of the user at the edge touch area of the terminal; or
operation information generated after clicking operation of the user at the edge touch area of the terminal; or
operation information generated after pressing operation of the user at the edge touch area of the terminal.
